(19) United States
(12) Patent Application Publication
(10) Pub. No.: US 2004/0158545 A1
(43) Pub. Date: Aug. 12, 2004

(54) System and method for an expert architecture

(75) Inventor: Andre Turgeon, Cedar Hills, UT (US)

Correspondence Address: Van Pelt & Yi LLP, Suite 200, 10050 N. Foothill Blvd., Cupertino, CA, 95014, US

(73) Assignee: Symantec Corporation

(21) Appl. No.: 10/365,570

(22) Filed: Feb. 12, 2003

(51) Int. Cl. G06F 17/00; G06N 5/02

(52) U.S. Cl. 706/46

(57) ABSTRACT

A system and method are disclosed for providing an expert system. In an embodiment of the present invention, a selected goal is received and a first record obtained. The first record is used to produce a second record, wherein the second record has a record type associated with it. It is then determined whether the record type is directly associated with the selected goal, and the second record is outputted if the record type is directly associated with the selected goal.

### FIELD OF THE INVENTION

The present invention relates generally to a system and method for obtaining data. More specifically, an expert system architecture is disclosed.

### BACKGROUND OF THE INVENTION

An expert system is a computer program, which typically solves problems or returns data or conclusions aimed with a goal of having a competence comparable with human experts. One of the results of research in the area of artificial intelligence has been the development of techniques which allow the modeling of information at higher levels of abstraction. These techniques are embodied in programs that attempt to closely resemble human logic in their implementation and emulate human expertise in well-defined problem domains. Examples of applications of an expert system include the legal field, the medical field, thermal dynamics, and computer or network vulnerability assessment.

There are typically two methods used in executing an expert system: forward chaining, and backward chaining. According to “Expert Systems—Design and Development”, John Durkin, Prentice Hall, p. 100-106, forward chaining is an inference strategy that begins with a set of known facts, derives new facts using rules whose premises match the known facts, and continues this process until a goal state is reached or until no further rules have premises that match the known or derived facts. Backward-chaining is an inference strategy that attempts to prove a hypothesis by gathering supporting information.

An example of a forward chaining method is the Rete algorithm. A typical problem with the forward chaining method is that the result is not focused because the process usually starts with a group of facts and a huge quantity of information is derived. An advantage of the forward chaining method is that it is very efficient since it can derive the information in parallel.

A potential problem with the backward chaining method is that it is typically not efficient since one question is asked at a time and information is gathered one at a time. Accordingly, there can be a great number of interactions back and forth between requests and results. An advantage of the backward chaining method is that the resulting output tends to be focused.

What is needed is an expert system, which provides focus and high efficiency. The present invention addresses such needs.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a high level view of the expert system architecture according to an embodiment of the present invention.

FIG. 2 shows an example of a goal selection dialogue according to an embodiment of the present invention.

FIG. 3 is a flow diagram of a method according to an embodiment of the present invention for an expert system.

FIG. 4 is another flow diagram of a method according to an embodiment of the present invention for an expert system.

FIG. 5 is a flow diagram of method according to an embodiment of the present invention for asserting a record.

FIG. 6 is an example of an analyzer/collector hierarchy according to an embodiment of the present invention.

### DETAILED DESCRIPTION

It should be appreciated that the present invention can be implemented in numerous ways, including as a process, an apparatus, a system, or a computer readable medium such as a computer readable storage medium or a computer network wherein program instructions are sent over optical or electronic communication links. It should be noted that the order of the steps of disclosed processes may be altered within the scope of the invention.

A detailed description of one or more preferred embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

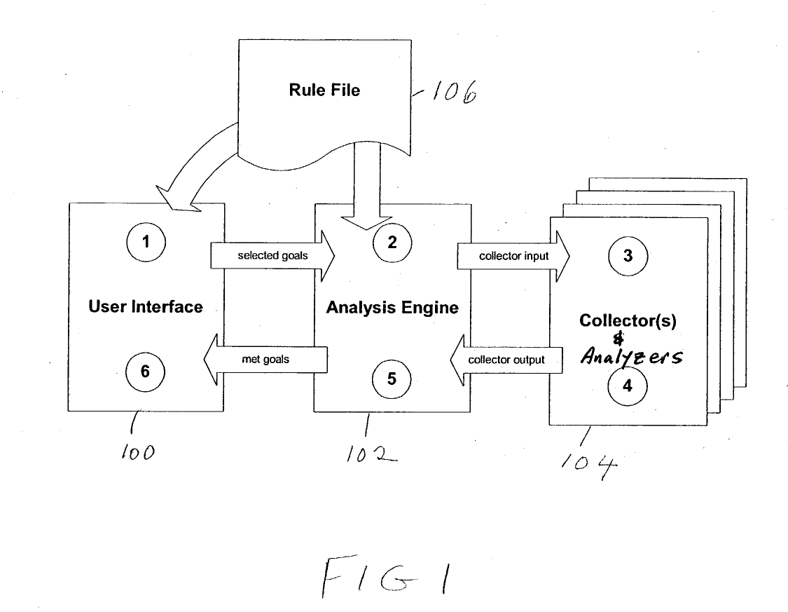

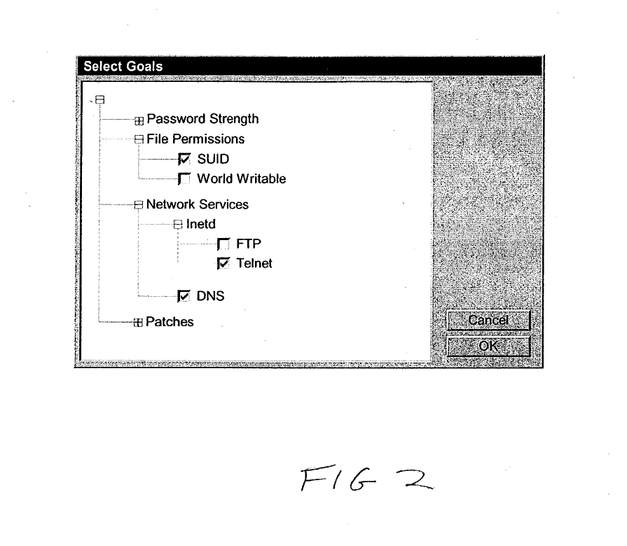

FIG. 1 is a high level view of the expert system architecture according to an embodiment of the present invention. This expert system architecture can be used for all expert system applications such as computer or network vulnerability assessment, legal research, and medical diagnosis. In this embodiment, the user is presented with a hierarchy of goals through the user interface 100. An example of a goal selection dialogue is shown in FIG. 2. Using the displayed goal options, the user can select desired goals to initiate a search result. When a user selects a goal, all of the goal's parents are preferably automatically selected. For example, if the user selects Telnet in the example shown in FIG. 2, then Inetd and Network Services are also automatically selected as being fields of interest to this particular user.

Records embedded in the selected goals are asserted through the analysis engine 102. Theses embedded records, herein referred to as triggers, can be used as input records to a collector or analyzer. A record, as used herein, can be any piece of information packaged in a format readable by the analysis engine. For example, a record format can look like the following: {!Book Title=“Dune”, publish-date=“Oct. 3, 1967”}, where “Book” is the record type, “Title” is a field, “Dune” is the value of the field “Title”, “publish-date” is another field, and “Oct. 3, 1967” is the value of the field “publish-date”. A collector can be any program such as an interface, a sensor, or an agent, that collects information from the world outside of the analysis engine. A collector, as used herein, operates on a request, preferably, with fixed logic. Each collector is preferably a different program and founds at the bottom of the hierarchy and gathers information directly from the system. A collector is preferably used for tasks that do not change often since it is preferably hard coded.

An analyzer can also be any program that collects information. An analyzer operates on a set of rules (such as inference rules) and goals and requests. All analyzers preferably use the same program but different rules and data. Analyzers can be stacked n-levels high, preferably with low level analyzers given low level rules and high level analyzers given more abstract rules. An analyzer can gather information from either collectors or lower level analyzers. An analyzer can be used for tasks that change often since the rules can be changed frequently for the analyzer.

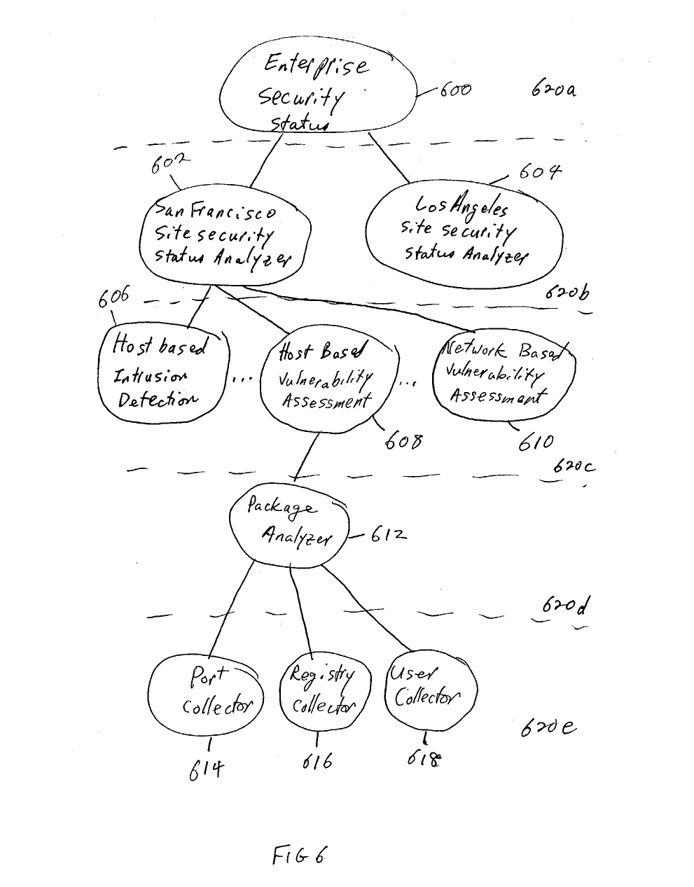

Although the present invention can be implemented without a single collector, it is preferable to have at least one collector. There is no limit to the number of collectors/analyzers that can be used. Further details of the analyzer/collector hierarchy will later be discussed in conjunction with FIG. 6.

The triggers can also serve as input to rules as part of the process performed by the analysis engine 102. The analysis engine 102 selects a particular record, preferably based on the record type of the record, to be used as an input to the collectors or analyzers. In one embodiment, there are various specialized collectors and analyzers. For example, one collector can be a collector for book titles, another for movie titles, and yet another for audio titles. There can be collectors with subcategories such as a subcategory of the “books” collectors, which specifically collects science fiction books. Examples of collectors in the vulnerability assessment field include “operating system version” collector, “registry” collector, “open port” collector, and “port banner” collector. The analysis engine 102 directs input records to the appropriate collectors or analyzer 104. One example of how the analysis engine 102 directs input records to appropriate collectors or analyzers is to use a look-up table of the kinds of input accepted by certain collectors or analyzers, compared with a record type of a record. Accordingly, the input record is automatically routed to an appropriate collector or analyzer 104.

The collector or analyzer receives the input record and uses it to specify the information desired. A collector or analyzer may accept more than one input record type. Examples of record types in the vulnerability assessment field include “IIS” and “Apache http server”.

The collector or analyzer packages the information that it has collected into a record and sends it back to the analysis engine 102. The collector or analyzer may return more than one record for a given request. In this manner, the output of the collector/analyzer 104 is automatically routed to the analysis engine 102.

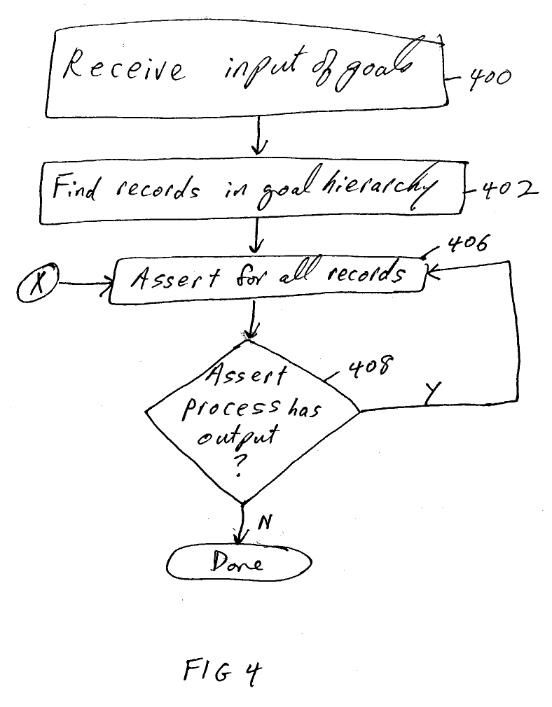

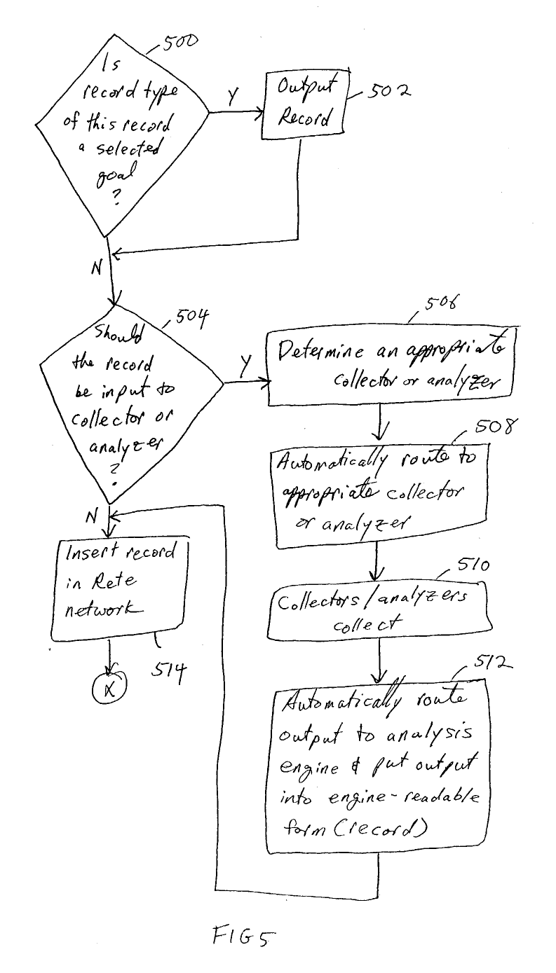

In an embodiment of the present invention, each record received from a collector analyzer 104 is asserted into the analysis engine 102. Further details of the assertion of the record will later be discussed in conjunction with FIGS. 4 and 5. These records are applied to applicable rules. The rules filter out these records according to its predicates. When all the predicates of a particular rule are met, a new record is created and its memberships populated using values from the triggering records. Triggering records are records that have met certain rules. An example of a rule is if IIS is running and file sharing is enabled, then there may be vulnerability to a particular worm.

Finally, the requested results are displayed. The displayed results are preferably records that are the same type as the selected goal. For example, if a user selected goal is “books that where turned into movies”, then a displayed result would be a particular book that was turned into a movie. This record of the book would have a record type of “books that where turned into movies”. Unselected goal records, such as “movies turned into books”, maybe asserted internally but will preferably not be displayed to the user as an output.

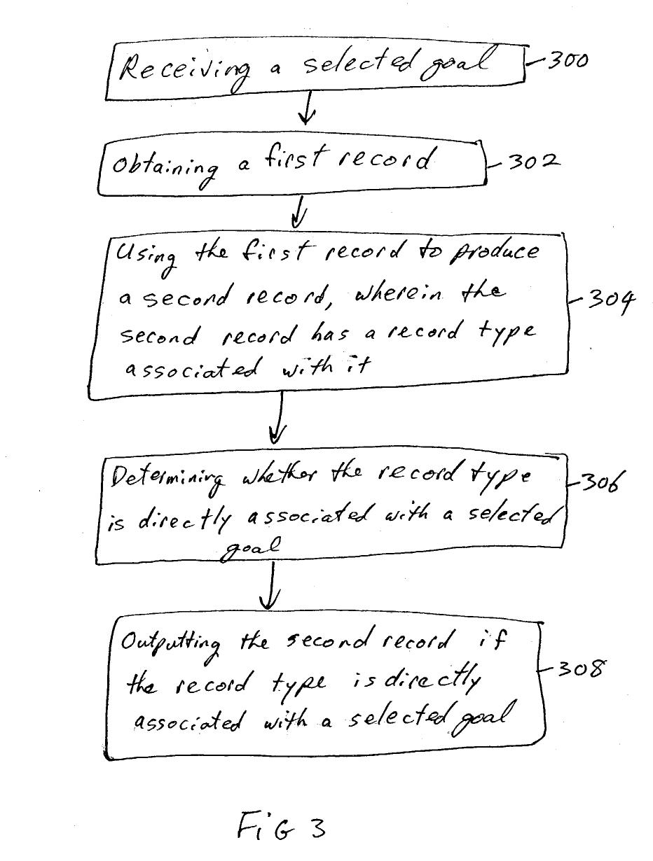

FIG. 3 is a flow diagram of a method according to an embodiment of the present invention for a system and method for an expert system. In this example, a selected goal is received (300). A first record is then obtained (302). The first record is then used to produce a second record, wherein the second record has a record type associated with it (304). It is then determined whether the record type is directly associated with a selected goal (306). The second record is displayed if the record type is directly associated with a selected goal (308).

FIG. 4 is another flow diagram of a method according to an embodiment of the present invention for an expert system. Input of goals is received (400). Initially, the input is preferably user input that can be received from a list of goals. In the example shown in FIG. 2, the user input of selected goals includes SUID TELNET, DNS, along with parent goals FILE PERMISSIONS, and NETWORK SERVICES. When the method of FIG. 4 is used by an analyzer that is lower in the hierarchy of analyzers, the input of goals is preferably received from an analyzer that is higher in the hierarchy. Further details of the analyzer hierarchy will later be discussed in conjunction with FIG. 6.

Records are found in the selected goal hierarchy (402). A record embedded in a goal is sometimes referred to herein as a trigger. In this embodiment, all triggers are asserted (406). Further details of the assert process will later be discussed in conjunction with FIG. 5.

It is then determined whether the assert process has output (408). If it does have output, then preferably all output is placed back into the assert process (406). If there is no output, the process is finished.

FIG. 5 is a flow diagram of method according to an embodiment of the present invention for asserting a record. For example, the method shown in FIG. 5 can be used as the assert step 406 of FIG. 4.

It is determined whether the record type of this particular record is a selected goal (500). For example, if the selected goal is “available computer ports”, then it is determined whether this record type is “available computer ports”. If the record type is a selected goal, then the record is output (502) and displayed to the user. Whether or not the record type of this record is a selected goal, it is determined whether the record should be input to a particular collector/analyzer (504). The record type of the record determines which collector/analyzer to use. If it is determined that the record should be input into a collector/analyzer, an appropriate collector/analyzer is determined (506). For example, if the record type is “available computer ports”, then an appropriate collector/analyzer may be “port” collector.

The record is automatically routed to an appropriate collector/analyzer (508). The collectors/analyzers then collect information (510). The information collected by the collectors/analyzers is automatically routed to the analysis engine and put into engine readable form (record)(512). Thereafter, the record is inserted into the Rete network (514). Alternatively, after routing the output to the analysis engine (512), it can be determined whether the assert process has output (408 of FIG. 4).

If the record is determined not to be put into a collector/analyzer (504 FIG. 5), then the record is inserted into the Rete network (514). The Rete network is well known to those skilled in the art. The Rete network is preferably part of the analysis engine and applies rules to the input record to create an output record deduced from the rules. The Rete network is derived from the rules. The rules can be supplied by a file and the rules describe what conclusion is desired. An example of a rule is if IIS is running and file sharing is enabled, then there may be vulnerability to a particular worm. Thereafter, it is determined whether the assert process has an output (406 of FIG. 4).

FIG. 6 is an example of an analyzer/collector hierarchy according to an embodiment of the present invention. In this example, there are five levels of analyzer/collector hierarchy 620a-620e, with 620a being the highest level and 620e being the lowest level. At the highest level 620a, there is shown an example of an analyzer called “enterprise security status” 600. It analyzes information collected from analyzers 602 and 604 which are called “San Francisco site security status analyzer” and “Los Angeles site security status analyzer”. Analyzers 602 and 604 analyzes information collected from analyzers at the next lower level 620c. In this example, analyzer 602 analyzes information collected analyzers 606-610. Analyzer 604 also analyzes information from its own set of lower level analyzers, not shown here for simplification. In turn, the “Host based vulnerability assessment” analyzer 608 is shown to analyze information collected by the next lower level analyzer “package analyzer” 612. Finally, when the lowest level 620e is reached, the analyzer 612 uses collectors 614-618 to gather information for it.

Each of these analyzers 600-618 preferably iterate through the method shown in FIGS. 4 and 5 with a different set of rules and a different set of goals set by the user if it is at the highest level, or by the requesting analyzer if it is at a lower level.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. A method for an expert system comprising:
receiving a selected goal;
obtaining a first record;
using the first record to produce a second record, wherein the second record has a record type associated with it;
determining whether the record type is directly associated with the selected goal; and
outputting the second record if the record type is directly associated with the selected goal.

2. The method of claim 1, wherein the selected goal is a user selected goal selected from a displayed list.

3. The method of claim 1, wherein the selected goal is received from an analyzer.

4. The method of claim 1, wherein the selected goal is part of a goal hierarchy wherein a parent of the selected goal is automatically selected as a second selected goal.

5. The method of claim 1, further comprising automatically routing the first record to a collector.

6. The method of claim 1, further comprising automatically routing the first record to a collector.

7. The method of claim 1, further comprising automatically routing the first record to a collector and automatically routing the second record from the collector.

8. The method of claim 1, further comprising automatically routing the first record to an analyzer and automatically routing the second record from the analyzer.

9. The method of claim 1, further comprising selecting a collector to route the first record.

10. The method of claim 1, further comprising selecting an analyzer to route the first record.

11. The method of claim 10, wherein the analyzer is associated with a hierarchy of analyzers.

12. The method of claim 10, wherein the analyzer routes a third record to a second analyzer.

13. The method of claim 12, wherein the second analyzer uses the third record to produce a fourth record.

14. The method of claim 12, further comprising:
using the third record by the second analyzer to produce a fourth record, wherein the fourth record has a second record type associated with it;
determining whether the second record type is directly associated with a goal associated with the third record; and
outputting the fourth record if the second record type is directly associated with the goal associated with the third record.

15. The method of claim 1, further comprising inputting the second record into a Rete network.

16. The method of claim 1, further comprising applying the second record to a set of rules.

17. The method of claim 1, wherein the expert system is used to perform computer vulnerability assessment.

18. The method of claim 1, wherein the expert system is used to perform medical diagnosis.

19. The method of claim 1, wherein the expert system is used to perform legal research.

20. A system for an expert architecture comprising:
a processor configured to receive a selected goal; obtain a first record; use the first record to produce a second record, wherein the second record has a record type associated with it; determine whether the record type is directly associated with the selected goal; and
output the second record if the record type is directly associated with the selected goal; and
a memory coupled to the processor to provide instructions.

21. A computer program product for an expert system, the computer program product being embodied in a computer readable medium and comprising computer instructions for:
receiving a selected goal;
obtaining a first record;
using the first record to produce a second record, wherein the second record has a record type associated with it;
determining whether the record type is directly associated with the selected goal; and
outputting the second record if the record type is directly associated with the selected goal.
